(19) United States
(12) Patent Application Publication
(10) Pub. No.: US 2025/0109858 A1
(43) Pub. Date: Apr. 3, 2025

(54) DUAL FUEL RANGE APPLIANCE

(71) Applicant: Midea Group Co., Ltd., Shunde (CN)

(72) Inventors: Felix Conde Zelocuatecatl, Louisville, KY (US); Chuanchuan Xie, Louisville, KY (US); Richard W. Cowan, Buford, GA (US)

(21) Appl. No.: 18/476,822

(22) Filed: Sep. 28, 2023

(51) Int. Cl. F24C 1/02; F24C 15/32; H05B 3/14

(52) U.S. Cl. CPC F24C 1/02; F24C 15/322; H05B 3/145

(57) ABSTRACT

A range may be a dual fuel appliance. The range may have one or more stove tops and one or more ovens. The cooking appliance may be used in a recreational vehicle.

### BACKGROUND

The present embodiments relate to a cooking appliance, with particular embodiments shown for a range appliance for a recreational vehicle.

Typical ranges in recreational vehicles are of a single fuel such as only liquid propane gas. It has been found that these gas burner oven cavities have reduced volume and/or functionality therein. Further, the range may only function if the single fuel is available. Thus, there is a need for providing dual fuels to the range (e.g. recreational vehicle), increase functionality of the one or more oven cavities (e.g. air frying, air circulation), provide an electrical power supply and/or gas supply to one or more oven cavities/cooking elements, provide a gas supply and/or electrical power supply to the one or more stove tops/cooking elements, operation (e.g. separate, concurrent) of the fuel types and/or cooking elements, and/or increase the volume of the oven cavity.

The present invention is directed at overcoming, or at least improving upon, the disadvantages of the prior art.

### SUMMARY

In some embodiments, a range for a recreational vehicle may include one or more ovens and one or more stove tops. In various embodiments, the oven may include one or more electrical cooking elements. In some embodiments, the stove top includes one or more gas burners. In various embodiments, the one or more electrical cooking elements may be configured to operate on a first fuel type. In some embodiments, the first fuel type may be electricity. In various embodiments, the one or more gas burners are configured to operate on a second fuel type different from the first fuel type, wherein the second fuel type is a gas.

In addition, in some embodiments, the one or more ovens may include one or more fans. In various embodiments, the one or more electrical cooking elements may be one or more graphite heating elements. In some embodiments, the one or more ovens may include one or more reflective heat surfaces. In various embodiments, the one or more electrical cooking elements may be electrically connected to a 120 volt power supply. In some embodiments, the second fuel type may be liquid propane. In various embodiments, the range may be combined with a recreational vehicle. In some embodiments, the range may be used in a non-residential housing application. In various embodiments, the range may include a controller configured to operate the range with respect to an air conditioning unit and/or a refrigerator. In some embodiments, the range may be a dual fuel range. In some embodiments, the range may include two or more ovens, wherein each oven uses a different fuel type. In various embodiments, a range may include a first oven that may include one or more electrical cooking elements and a second oven that may have one or more gas burners.

In some embodiments, a recreational vehicle may have a dual fuel range. In various embodiments, the recreational vehicle may include a range having one or more stove tops and one or more ovens. In some embodiments, at least one oven may include one or more electrical cooking elements. In various embodiments, at least one stove top may include one or more gas burners. In various embodiments, the recreational vehicle may include a gas connection in communication with the one or more gas burners of the stove top and/or oven. In some embodiments, the recreational vehicle may include one or more electrical connection in communication with the one or more electrical cooking elements of the oven and/or stove top.

In addition, in some embodiments, the one or more ovens may include one or more fans. In various embodiments, the one or more electrical cooking elements may be one or more graphite heating elements. In some embodiments, the one or more ovens may include one or more reflective heat surfaces. In various embodiments, the one or more electrical cooking elements may be configured to operate on a 120 volt power supply. In some embodiments, the one or more electrical cooking elements may be configured to operate on a 15 amp, 20 amp, 30 amp, 50 amp, and/or 60 amp power supply. In some embodiments, the range may include two oven cavities. In various embodiments, one oven may include one or more electrical cooking elements and another oven may have one or more gas burners. In some embodiments, the one or more gas burners of another oven may be in communication with the gas connection.

In some embodiments, a method of operating a range for a recreational vehicle may include providing a range having one or more burners in at least one stove top and one or more electrical cooking elements in at least one oven. In various embodiments, the method may include providing electricity to the one or more electrical cooking elements in the oven. In some embodiments, the method may include providing gas to the one or more gas burners in the stove top.

In addition, in some embodiments, the electricity provided may be a 120 volt power supply. In various embodiments, the one or more electrical cooking elements may be configured to operate on a 15 amp, 20 amp, 30 amp, 50 amp, and/or 60 amp power supply. In some embodiments, the one or more electrical cooking elements may be at least one graphite heating element. In various embodiments, the method may include managing power supply to the range to the detriment of other electrical devices within the recreational vehicle. In some embodiments, the method may include air frying food within the oven. In various embodiments, the range may include one or more electrical cooking elements in one oven and one or more burners in another/additional oven, and providing gas to the one or more gas burners in the another/additional oven. In some embodiments, a range may have two or more ovens with each oven using a different fuel type/cooking element.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of one embodiment of a recreational vehicle and a cooking appliance consistent with some embodiments of the invention.

FIG. 2 is a block diagram of an example control system for a range/appliance consistent with some embodiments of the invention.

FIG. 3 is a front view of the example range of FIG. 1 with the door in the open position, and the racks and corresponding rails removed.

FIG. 4 is a perspective view of the range of FIG. 1 with portions of the range broken away to illustrate portions within the oven/oven cavity.

FIG. 5 is a sectional view of the example range taken along line 5-5 of FIG. 4, and the door removed.

FIG. 6 is a diagrammatic front view of an example dual fuel range, illustrating a stove top with at least a gas burner cooking element and a plurality of ovens, a first/top oven having at least an electrical cooking element and a second/bottom oven having at least a gas burner cooking element.

FIG. 7 is a diagrammatic front view of an example dual fuel range, illustrating a stove top with at least an electrical cooking element and an oven having at least a gas burner cooking element.

### DETAILED DESCRIPTION

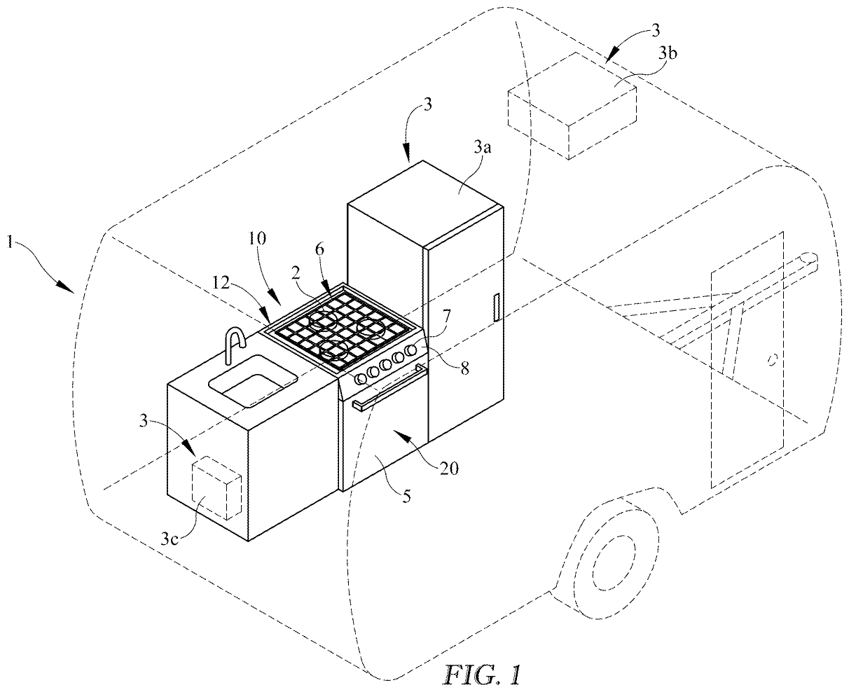

Turning now to the drawings, wherein like numbers denote like parts throughout the several views, FIG. 1 illustrates an example cooking appliance 10 (e.g. range, dual fuel range) in which the various technologies and techniques described herein may be implemented. Cooking appliance 10 may be a range, and as such includes a housing 12, one or more stove tops or cooktops 6 (e.g. a plurality of burners 2, cooking elements of one or more fuel types) and/or one or more ovens 20 (e.g. a plurality of electrical cooking elements 23, cooking elements of one or more fuel types) defining an one or more oven or cooking cavities 14 accessed via one or more oven doors 5. The housing 12 (e.g. one or more walls/sides) may include or define one or more cooking cavities or adjustable cooking volumes 14. Cooking appliance 10 may also include a storage drawer, second oven, a broiler drawer, a warming drawer, or a cover (e.g. no drawer). Various cooking elements (e.g. use of two or more different fuel types/cooking elements) may also be incorporated into cooking appliance 10 for cooking food in oven(s) 20 and/or stove top(s) 6 and still be a dual fuel range, e.g., one or more electrical cooking/heating elements 23, one or more gas burner cooking elements 2.

Cooking appliance 10 may also include various user interface devices, including, for example, control knobs 7 and/or a control panel 8 for controlling the oven 20, fan 21, gas supply 70, electrical supply 30, gas burner 2, motor 22, electrical cooking element(s) 23, other electrical devices 3 (e.g. refrigerator, water heater, air conditioning unit, internal/integrated with the recreational vehicle, external to the recreational vehicle, electric furnace, microwave, washer, dryer, garbage disposal, awning, jacks, etc.), and/or burners 2. It will be appreciated that cooking appliance 10 may include various types of user controls in other embodiments, including various combinations of switches, buttons, knobs and/or sliders, typically disposed at the rear or front (or both) of the cooking appliance. Further, in some embodiments, one or more touch screens may be employed for interaction with a user and/or a display for providing visual feedback as to the activation state of the cooking appliance. As such, in some embodiments, the display may be touch sensitive to receive user input in addition to displaying status information and/or otherwise interacting with a user. In still other embodiments, cooking appliance 10 may be controllable remotely, e.g., via a smartphone, tablet, personal digital assistant or other networked computing device, e.g., using a web interface or a dedicated app.

The display may also vary in different embodiments, and may include individual indicators, segmented alphanumeric displays, and/or dot matrix displays, and may be based on various types of display technologies, including LEDs, vacuum fluorescent displays, incandescent lights, etc. Further, in some embodiments audio feedback may be provided to a user via one or more speakers, and in some embodiments, user input may be received via a spoken or gesture-based interface.

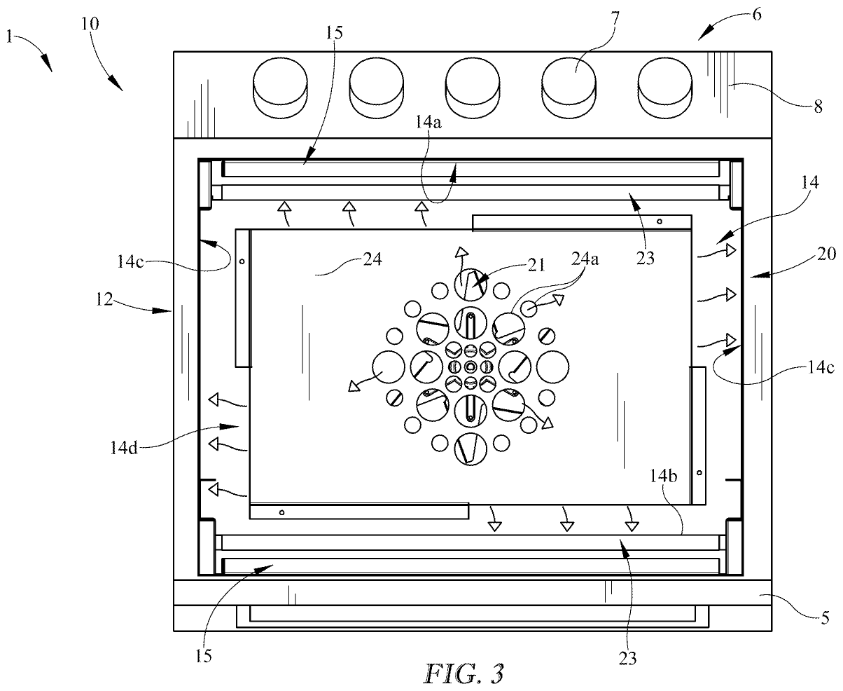

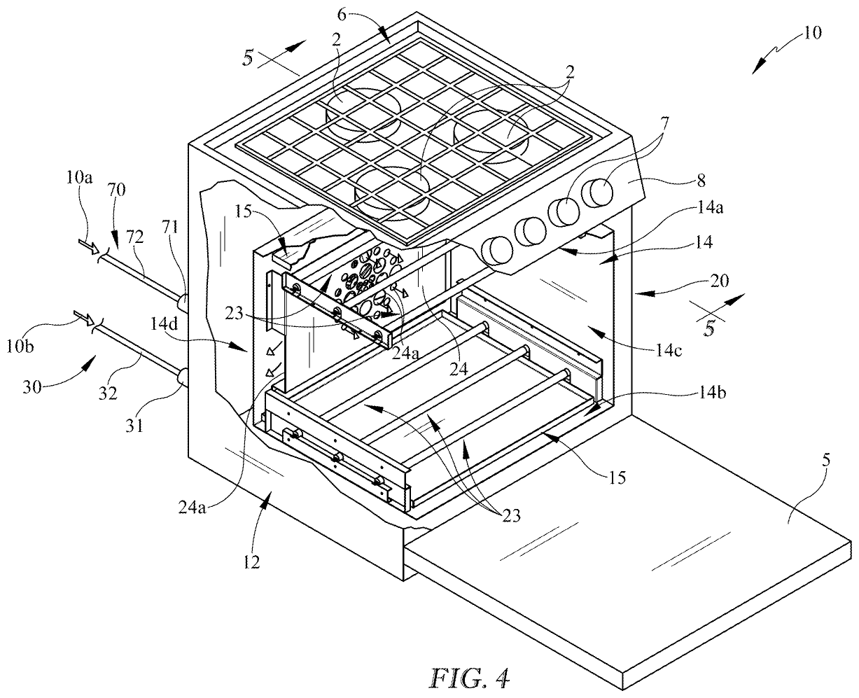

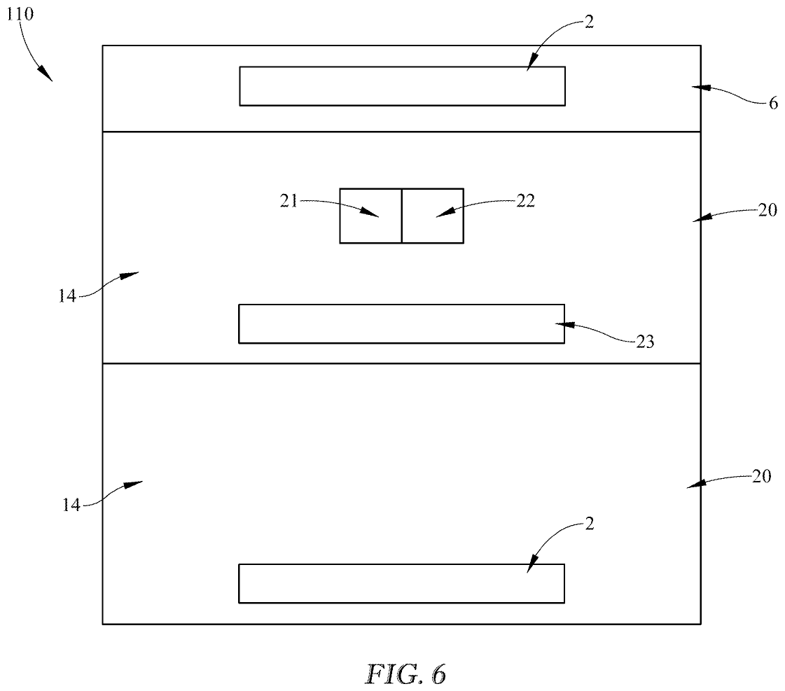

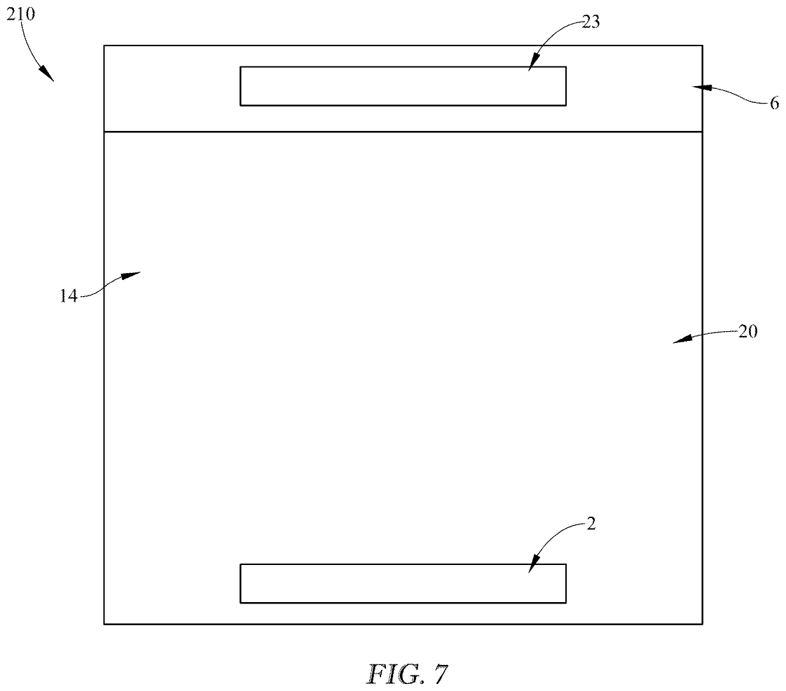

As noted above, cooking appliance 10 of FIG. 1 is a range, which combines both a stove top 6 and one or more ovens 20, and which in some embodiments may be a standalone or drop-in type of range. In other embodiments, however, cooking appliance 10 may be another type of cooking appliance, e.g., a wall oven or freestanding oven. The oven 20 and stove top 6 may be within one or more housings. In general, a cooking appliance consistent with the invention may be considered to include any appliance including dual fuels (e.g. both electrical and gas heating/cooking elements). As shown in the one embodiment in FIGS. 1-5 a housing 12 with a stove top 6 includes one or more gas burners 2 and one or more electrical cooking elements 23 disposed in one or more cavities 14 and configured to generate energy for cooking food. As shown in the one embodiment in FIG. 6, the housing with a stove top 6 and one or more ovens 20 (e.g. bottom) includes one or more gas burners 2 and one or more electrical cooking elements 23 disposed in one or more cavities 14 or ovens 20 (e.g. top) and configured to generate energy for cooking food. As shown in the one embodiment in FIG. 7a housing with a stove top 6 includes one or more electrical cooking elements 23 (e.g. induction cooking elements) and one or more gas burners 2 disposed in one or more cavities 14 or ovens 20 and configured to generate energy for cooking food. Further, for example, the cooking appliance 10 may be included in a recreational vehicle 1 as shown in the one embodiment in FIGS. 1-5. Although the recreational vehicle 1 is shown in the one embodiment as a pull behind camper, it should be understood that the recreational vehicle may be a fifth wheel coupling camper, teardrop tailer, expandible trailer, pop-up camper, truck camper, campervan, van, motorhome (e.g. Class B, Class C, etc.), trailer, toy hauler RV, slide in truck camper, conventional travel trailer, boat, yacht, house boat, etc. and still be within the scope of the invention. The recreational vehicle 1 may be considered a non-residential housing application and/or moveable appliance/apparatus/vehicle. Although the appliance is shown in use for a recreational vehicle, it should be understood that the cooking appliance may be used in residential/commercial applications.

In turn, the dual fuel range 10, 110, 210 may be an appliance with at least two different fuel types or technologies operating one or more different cooking elements 2, 23, 48. For example, a first fuel type 10a (e.g. gas supply 70) and/or first cooking element(s) (e.g. gas burner 2) and a second fuel type 10b (e.g. electrical supply 30) and/or second cooking element(s) (e.g. electrical cooking element 23) different from the first fuel type 10a and/or first cooking element(s). In the one embodiment shown in FIGS. 1-5, the stove top 6 and/or stove top/first cooking elements (e.g. one or more gas burners 2) may include and/or operate on at least one first fuel type 10a (e.g. gas) and the oven 20/cavity 14 and/or oven/second cooking elements (e.g. one or more electrical cooking elements 23) may include and/or operate on at least one second fuel type 10b (e.g. electricity, AC, DC) different from the first fuel type 10a and/or first cooking element. In the one embodiment shown in FIG. 6, the stove top 6 and/or stove top/first cooking elements (e.g. one or more gas burners 2) and/or the second/bottom oven 20/cavity 14 and/or oven/third cooking elements (e.g. one or more gas burners) may include and/or operate on at least one first fuel type 10a (e.g. gas) and the first/top oven 20/cavity 14 and/or oven/second cooking elements (e.g. one or more electrical cooking elements 23) may include and/or operate on at least one second fuel type 10b (e.g. electricity, AC, DC) different from the first fuel type 10a and/or first/third cooking elements. In the one embodiment shown in FIG. 7, the stove top 6 and/or stove top/first cooking elements (e.g. one or more electrical cooking elements 23) may include and/or operate on at least one first fuel type 10b (e.g. electricity, AC, DC) and the oven 20/cavity 14 and/or oven/second cooking elements (e.g. one or more gas burners 2) may include and/or operate on at least one second fuel type 10a (e.g. gas) different from the first fuel type 10a and/or first cooking element. It should be understood that a variety of cooking elements may be used in one or more portions of the range that have different fuel type requirements. In some embodiments, the first fuel type 10a may be gas (e.g. liquid propane, natural gas) and the second fuel type 10b may be electricity (e.g. 120 volt, DC, AC, 15 amp, 20 amp, 30 amp, 50 amp, 60 amp). The respective fuel type may be configured to one or more cooking elements (e.g. corresponding to one or more positions/devices within the range) to include practically any type of energy-producing element used in residential applications in connection with cooking food, e.g., employing various cooking technologies such as electric, gas, light, microwaves, induction, convection, radiation, etc. In the case of the oven, for example as shown in the one embodiment in FIGS. 1-5, one or more cooking elements/ovens therein may be electrically driven such as but is not limited to electric, light, or microwave cooking elements in some embodiments, while in the case of the stove top, one or more cooking elements therein may be gas/combustion driven such as but is not limited to a gas burner cooking element in some embodiments. In the case of the first/top oven 20, for example as shown in the one embodiment in FIG. 6, one or more cooking elements/ovens therein may be electrically driven such as but is not limited to electric, light, or microwave cooking elements and the second/bottom oven 20 may have one or more cooking elements/ovens therein gas/combustion driven such as but is not limited to a gas burner cooking in some embodiments, while in the case of the stove top 6, one or more cooking elements therein may be gas/combustion driven such as but is not limited to a gas burner cooking element in some embodiments. Further in the case of the oven, for example as shown in the one embodiment in FIG. 7, one or more cooking elements/ovens therein may be gas/combustion driven such as but is not limited to a gas burner cooking element in some embodiments, while in the case of the stove top, one or more cooking elements therein may be electrically driven such as but is not limited to electric or induction in some embodiments. Further, it will be appreciated that any number of cooking elements may be provided in the cooking appliance corresponding to one or more fuel types supplied (including multiple cooking elements for performing different types of cooking cycles such as baking, air frying, and/or broiling, including multiple bake and/or multiple broiler cooking elements, as well as one or more convection cooking elements), and that multiple types of cooking elements may be combined in some embodiments, e.g., combinations of microwave, induction, gas, and light cooking elements in some oven embodiments.

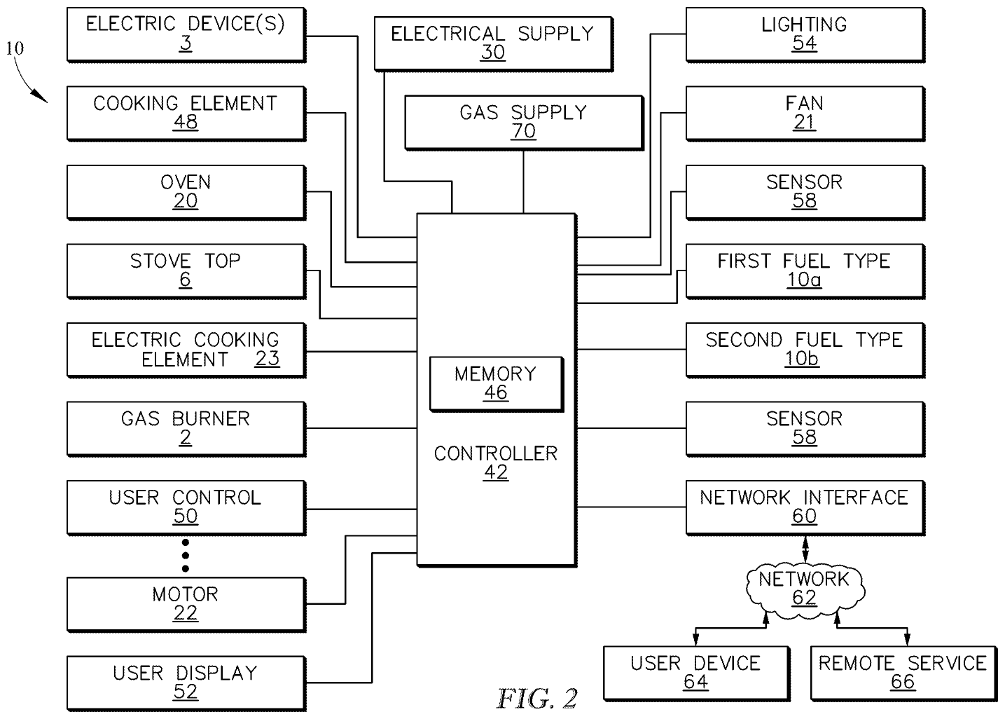

A cooking appliance 10, 110, 210 consistent with the invention also generally includes one or more controllers configured to control the cooking elements and otherwise perform cooking operations at the direction of a user. FIG. 2, for example, illustrates an example embodiment of a cooking appliance 10 including a controller 42 that receives inputs from a number of components and drives a number of components in response thereto. Controller 42 may, for example, include one or more processors 44 and a memory 46 within which may be stored program code for execution by the one or more processors. The memory may be embedded in controller 42, but may also be considered to include volatile and/or non-volatile memories, cache memories, flash memories, programmable read-only memories, read-only memories, etc., as well as memory storage physically located elsewhere from controller 42, e.g., in a mass storage device or on a remote computer interfaced with controller 42.

As shown in FIG. 2, controller 42 may be interfaced with various components, including various cooking elements 48 used for cooking food (e.g., various combinations of gas, electric, inductive, light, microwave, light cooking elements, air fryer heating element, among others), one or more user controls 50 for receiving user input (e.g., various combinations of switches, knobs, buttons, sliders, touchscreens or touch-sensitive displays, microphones or audio input devices, image capture devices, etc.), and a user display 52 (including various indicators, graphical displays, textual displays, speakers, etc.), as well as various additional components suitable for use in a cooking appliance, e.g., lighting 54 and/or one or more fans 21 (e.g., convection fans, cooling fans, air fryer fan, etc.), among others. For cooking elements 48 implemented as gas burners 2 in the stove top 6, controller 42 may be interfaced with one or more gas valves/supply for regulating gas flow to the gas burners, as well as one or more ignitors for igniting gas supplied to the gas burners; however, these components are not illustrated separately in FIG. 2. For cooking elements 48 implemented as electrical cooking elements 23 in the oven 20, controller may be interfaces with one or more other appliances/devices 3 within the recreational vehicle 1, such as but is not limited to the AC unit 3b, refrigerator 3a, water heater 3c, etc. The controller 42 may be configured to manage the power/electrical supply between the one or more electrical devices 3 (e.g. oven 20, AC unit 3b, refrigerator 3a, water heater 3c, etc.) to allow for sufficient voltage, amps, etc., to one or more devices when operating. The controller may supply/manage power/electricity supply to the oven 20/range 10/cooking element 23 (e.g. to the detriment of the other electrical devices 3 (e.g. recreational vehicle, AC unit, refrigerator, water heater, furnace, awning, garbage disposal, etc.)). For example, preventing the operation or power supply (e.g. voltage, amps) to the AC unit until the oven (e.g. electrical cooking element) is no longer in use. Alternatively, the controller may limit operation or power to the electrical oven for the benefit of the other electrical devices. The controller may be configured to operate the cooking appliance (e.g. oven, electrical cooking element) with respect to additional electric devices within the recreational vehicle (e.g. an air conditioning unit, a refrigerator, furnace, water heater, etc.).

Controller 42 may also be interfaced with various sensors 58 located to sense environmental conditions inside of and/or external to cooking appliance 10, e.g., one or more temperature sensors, humidity sensors, air quality sensors, smoke sensors, carbon monoxide sensors, odor sensors and/or electronic noise sensors, among others. Such sensors may be internal or external to cooking appliance 10, and may be coupled wirelessly to controller 42 in some embodiments. Sensors 58 may include, for example, one or more temperature sensors for sensing an air temperature within an oven cavity, including, for example, a temperature sensor for sensing temperature in a center of the oven cavity and/or one or more temperature sensors for sensing temperature in the top and/or bottom of the oven cavity, as well as one or more electrical cooking element detectors, e.g., detectors capable of sensing the electrical elements or heat emitted.

In some embodiments, controller 42 may also be coupled to one or more network interfaces 60, e.g., for interfacing with external devices via wired and/or wireless networks such as Ethernet, Wi-Fi, Bluetooth, NFC, cellular and other suitable networks, collectively represented in FIG. 2 at 62. Network 62 may incorporate in some embodiments a home automation network, and various communication protocols may be supported, including various types of home automation communication protocols. In other embodiments, other wireless protocols, e.g., Wi-Fi or Bluetooth, may be used. In some embodiments, cooking appliance 10 may be interfaced with one or more user devices 64 over network 62, e.g., computers, tablets, smart phones, wearable devices, etc., and through which cooking appliance 10 may be controlled and/or cooking appliance 10 may provide user feedback. Further, in some embodiments, cooking appliance 10 may be interfaced with one or more remote services 66, e.g., cloud-based services, remote servers.

In some embodiments, controller 42 may operate under the control of an operating system and may execute or otherwise rely upon various computer software applications, components, programs, objects, modules, data structures, etc. In addition, controller 42 may also incorporate hardware logic to implement some or all of the functionality disclosed herein. Further, in some embodiments, the sequences of operations performed by controller 42 to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

Numerous variations and modifications to the cooking appliances illustrated in FIGS. 1-7 will be apparent to one of ordinary skill in the art, as will become apparent from the description below. Therefore, the invention is not limited to the specific implementations discussed herein.

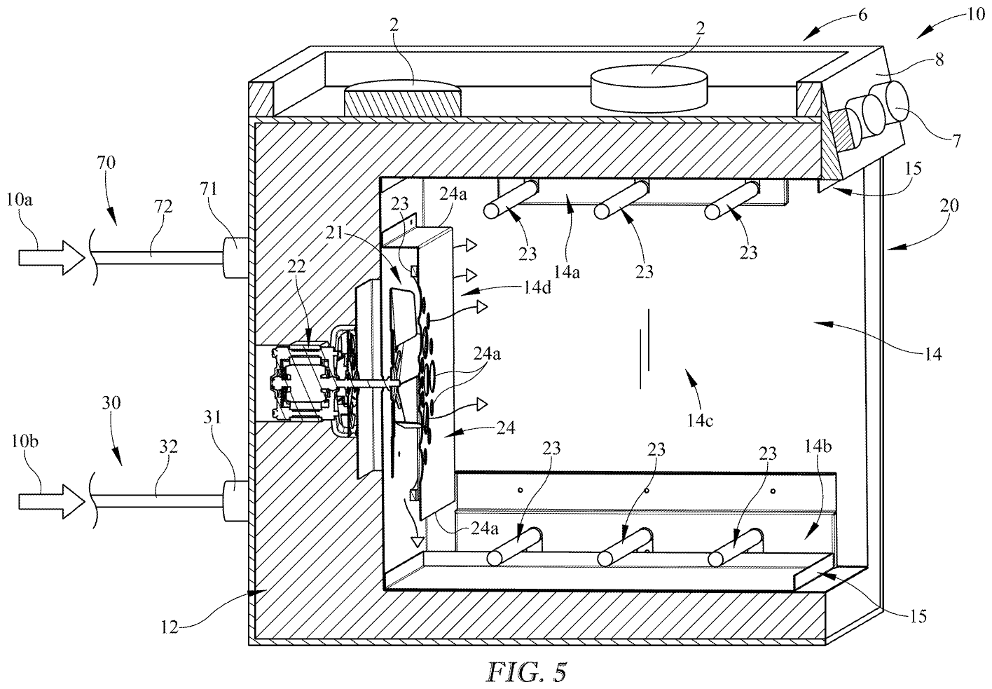

As noted above, in a cooking appliance 10, 210, stove top 6, and/or oven 20 relies on electrical supply/fuel 30 and/or electrical cooking elements 23 as oven/stove top cooking elements. The one or more electrical cooking elements 23 may be supplied by or in fluid communication with electricity or electrical supply 30. The appliance 10, in some embodiments, is generally designed to incorporate a path for drawing in fresh air for convection and/or circulating air (e.g. while air frying). FIGS. 1-6, for example, illustrates an example cooking appliance 10, 110 including a structure 12 defining an oven cavity 14. As shown in FIGS. 5 and 6, bake and/or broil electrical cooking elements 23 are disposed proximate the bottom 14b of the oven cavity 14 and/or top 14a of the oven cavity 14. In some embodiments, a bake and/or broil electrical cooking elements 23, not shown, may be disposed proximate the one or more sides 14c and/or rear 14d of the oven cavity 14. The appliance 10, 110, oven 20, and/or oven cavity 14 may include a fan 21 and/or motor 22 in fluid communication with the cavity 14. In the one embodiment shown in FIGS. 1-5, a fan 21 and/or motor 22, if used, may be positioned adjacent at least one wall (e.g. rear) of the oven cavity 14, or portions thereof, (e.g. rear, top, etc.) to circulate and/or introduce air into the cavity 14. An air flow panel or cover 24, if used, and/or the rear 14d may have one or more apertures 24a positioned between the fan 21 and cavity 14 to provide fluid communication (e.g. circulating) therebetween. In some embodiments, one or more electrical cooking elements 23 may be adjacent the fan 21 or heat the force air upstream and/or downstream of the fan. The cover 24, if used, and/or rear wall 14d may define one or more radial apertures 24a circulating air within the cavity. For example, as shown in the FIGS. 1-5, the radial apertures 24a are interrupted/spaced about the circumference of the fan 21 and/or adjacent cooking element 23, if used.

In some implementations, the dual fuel range 110 may include a gas burning stove top, at least one gas burning oven, and at least one electrical cooking oven. As shown in FIG. 6, a first fuel type (e.g. gas) may operate both the stove top 6 and at least one oven 20 via one or more first fuel type cooking elements (e.g. gas burners 2). Further, a second fuel type (e.g. electricity) may operate at least one oven 20 via one or more second fuel type cooking elements (e.g. electrical cooking elements, graphite, cal-rod). A fan 21 and/or motor 22, if used, may be included in at least one oven 20.

In some implementations, the dual fuel range 210 may include an electric stove top and at least one gas burning oven. As shown in FIG. 7, a first fuel type (e.g. electricity) may operate the stove top 6 via one or more first fuel type cooking elements (e.g. induction cooking elements 23, electrical cooking elements, coil). Further, a second fuel type (e.g. gas) may operate at least one oven 20 via one or more second fuel type cooking elements (e.g. gas burners 2).

Although the one or more electrical cooking elements 23 is shown as a graphite heating element (e.g. heating tube with graphite element) and/or induction cooking element, it should be understood that a variety of electrical cooking elements may be used within the oven cavity 14 and/or stove top 6 and still be within the scope of the invention. For example, a cal-rod type heating element may be used in some oven embodiments. Further, for example, a heating tub with quartz element may be used. In some embodiments, the heating element may be positioned around the fan blade or in front of the fan blades to heat up the intake air. Although the oven cooking element is shown in the one embodiment as a linear rod, it should be understood that the cooking element may be a variety of constructions or other geometries such as, but is not limited to, a rectangular shape or oval shape with one or more different passes.

The fan or blowing structure 21 may be a variety of structure, constructions, positions, shapes, and sizes and still circulate air flow, but is not limited to, an impeller, a flow-through type fan, a turbine-type fan, etc. The motor driven fan 21 (e.g. blades), or portions thereof, may be inside and/or radially inward from the oven or more cooking elements 23 as shown, however the fan may be in a variety of positions relative to the one or more electrical cooking elements 23 and still be within the scope of the invention. The motor 22 may be positioned behind the cover 24 in some embodiments. The fan 21, if used, and/or cover 24, if used, may allow for air frying within the cooking cavity 14 or oven 20 in some embodiments.

In some implementations, the oven 20 and/or oven cavity 14 may include one or more reflective heat surfaces 15. The reflective heat surface 15, if used, reflects heat back into the cavity 14 and/or towards the food. As shown in the one embodiment in FIGS. 1-5, the top and bottom walls 14a, 14b may include a reflective heat surface 15 such as, but is not limited to, aluminum. The remaining walls of the cavity 14 may be a cold rolled metal with an enamel coating. It should be understood that one or more walls, or portions thereof, may include a reflective heat surface.

In some implementations, the power/electrical supply 30 and/or a second fuel type 10b may be AC current and/or DC current. In various embodiments, the voltage may be about 110 volts to about 120 volts. In some embodiments, the voltage may be 120 volts plus or minus 10 volts. As shown in FIGS. 1-6, the one or more electrical cooking elements 23 of the oven 20 may be electrically connected to the electrical power supply (e.g. 120 volt). As shown in FIG. 7, the one or more electrical cooking elements 23 (e.g. induction devices) of the stove top 6 may be electrically connected to the electrical power supply (e.g. 120 volt). Although a variety of amperages/voltage may be used, the amperage of the power/electrical supply 30 may be 15 Amps, 20 Amps, 30 Amps, 50 Amps, and/or 60 Amps in some embodiments. Although not shown, the power/electrical supply may be at least a battery. The battery/DC current may be used alone or in combination with the AC current for the electrical cooking elements/range/oven.

In some implementations, the power/gas supply 70 and/or a first fuel type 10a may be one or more gases. The fuel type may be one or more gases. The stove top 6 and/or oven 20 may operate on one or more gases. As shown in FIGS. 1-6, the stove top 6 may include one or more burners 2 operating or supplied by one or more gases (e.g. LP, natural gas). As shown in FIGS. 5 and 6, the oven 20 may include one or more burners 2 operating or supplied by one or more gases (e.g. LP, natural gas). The one or more burners 2 may include one or more igniters, not shown, adjacent thereto. The one or more burners 2 may be supplied by or in fluid communication with the gas or gas supply 70. Although not shown, the oven 20 with burners 2 may include one or more fans.

In some implementations, the range 10, 110, 210 may operate or be controlled (e.g. controller) to utilize one or more of the fuels. The dual fuels may be used concurrently or separately between the variety of cooking elements. The first fuel and/or first cooking elements (e.g. burner) may be used alone or in combination with the second fuel and/or second cooking element (e.g. electrical cooking element). The second fuel and/or second cooking element (e.g. electrical cooking element) may be used alone or in combination with the first fuel and/or first cooking elements (e.g. burner). In some embodiments, the stove top 6/gas burner(s) 2 may operate when the oven 20/electrical cooking elements 23 is not being operated. In various embodiments, the oven/electrical cooking element(s) 23 may operate when the stove top/gas burner(s) are not being operated. In some embodiments, the oven/electrical cooking element(s) may operate when the stove top/gas burner(s) is operating. The user may be able to operate the stove top and/or gas burner when there is no or insufficient electrical supply available and/or if only the gas burner(s) is needed. Alternatively, the user may be able to operate the electrical cooking elements and/or oven when there is no or insufficient gas supply available and/or if only the oven is needed.

In some implementations, the range 10, 110, 210 and/or recreational vehicle 1 may have one or more dual fuel connections (e.g. gas, electric, first, second, etc.). The range 10, 110, 210 and/or recreational vehicle 1 may provide electricity to one or more electrical cooking elements (e.g. oven, stove top) and/or may provide gas to one or more gas burners (e.g. stove top, oven). For example in the one embodiment shown in FIGS. 1-5, the range 10 and/or recreational vehicle 1 may provide electricity to one or more electrical cooking elements (e.g. oven) and/or may provide gas to one or more gas burners (e.g. stove top). The first fuel or gas connection 71 of the range 10, 110, 210 may be configured for gas and is in communication with a gas line 72 or supply 70. The gas line 72 and/or first fuel connection 71 may be in communication with the one or more burners 2 of the stove top 6 and/or oven 20. The second fuel or electrical connection 31 of the range 10, 110, 210 may be configured for electricity and is in communication with an electrical line 32 or supply 30. The electrical line 32 and/or second fuel connection 31 may be in communication with the one or more electrical cooking elements 23 of the oven cavity 14, stop top 6, fan 21, and/or motor 22. Although the connections 71, 31 are shown as separate couplings in the one embodiment in FIGS. 1-5, it should be understood that the connections may be a single member or coupling having connections to their respective fuel source.

In some implementations, one or more portions of the appliance or cooking elements may operate on different fuels. The range may include one or more stove top cooking elements operating on one or more first fuel types and/or one or more second fuel types and one or more oven cooking elements operating on at least one different fuel than the one or more stove top cooking elements. For example, the stove top cooking element fuel type may be gas (e.g. gas burner) and the oven cooking elements fuel type may be both gas and electricity (e.g. in separate oven cavities, gas burner in a first cavity/oven, electrical cooking element in a second cavity/oven) (see FIG. 6). For example, the stove top cooking element fuel type may be electricity and the oven cooking elements fuel type may be both gas and electricity (e.g. in separate oven cavities). For example, the stove top cooking element fuel type may be electricity (e.g. induction) and the oven cooking element fuel type may be gas (see FIG. 7). For example, the stove top cooking element fuel type may be gas and the oven cooking element fuel type may be electricity (see FIGS. 1-5). For example, the stove top cooking elements fuel type may be both gas and electricity (e.g. a gas burner and an induction cooking element) and the oven cooking element fuel type may be gas (e.g. gas burner in the oven). Further, for example, the stove top cooking elements fuel type may be both gas and electricity and the oven cooking element fuel type may be electricity. Further, for example, the stove top cooking elements fuel type may be both gas and electricity, with no ovens. Alternatively, for example, the oven cooking elements fuel type may be both gas and electricity, with no stove top.

It will be appreciated that various additional modifications may be made to the embodiments discussed herein, and that a number of the concepts disclosed herein may be used in combination with one another or may be used separately. Therefore, the invention lies in the claims hereinafter appended.

1. A range for a recreational vehicle, comprising:
an oven and a stove top, wherein the oven includes one or more electrical cooking elements and the stove top includes one or more gas burners;
wherein the one or more electrical cooking elements are configured to operate on a first fuel type, wherein the first fuel type is electricity; and
wherein the one or more gas burners are configured to operate on a second fuel type different from the first fuel type, wherein the second fuel type is a gas.

2. The range of claim 1 wherein the oven includes a fan.

3. The range of claim 1 wherein the one or more electrical cooking elements are one or more graphite heating elements.

4. The range of claim 1 wherein the oven includes one or more reflective heat surfaces.

5. The range of claim 1 wherein the one or more electrical cooking elements is electrically connected to a 120 volt power supply.

6. The range of claim 1 wherein the second fuel type is liquid propane.

7. The range of claim 1 in combination with a recreational vehicle.

8. The range of claim 1 is used in a non-residential housing application.

9. The range of claim 1 further comprising a controller configured to operate the range with respect to an air conditioning unit and/or a refrigerator.

10. The range of claim 1 further comprising another oven having one or more gas burners.

11. A recreational vehicle having a dual fuel range, the recreational vehicle comprising:
a range having a stove top and an oven, wherein the oven includes one or more electrical cooking elements and the stove top includes one or more gas burners;
a gas connection in communication with the one or more gas burners of the stove top; and
an electrical connection in communication with the one or more electrical cooking elements of the oven.

12. The recreational vehicle of claim 11 wherein the oven includes one or more fans.

13. The recreational vehicle of claim 11 wherein the one or more electrical cooking elements are one or more graphite heating elements.

14. The recreational vehicle of claim 11 wherein the oven includes one or more reflective heat surfaces.

15. The recreational vehicle of claim 11 wherein the one or more electrical cooking elements is configured to operate on a 120 volt power supply.

16. The recreational vehicle of claim 11 wherein the one or more electrical cooking elements is configured to operate on a 15 amp, 20 amp, 30 amp, 50 amp, and/or 60 amp power supply.

17. The recreational vehicle of claim 11 wherein the range comprises another oven having one or more gas burners, wherein the one or more gas burners of the another oven is in communication with the gas connection.

18. A method of operating a range for a recreational vehicle comprising the steps of:
providing a range having one or more burners in a stove top and one or more electrical cooking elements in an oven;
providing electricity to the one or more electrical cooking elements in the oven; and
providing gas to the one or more gas burners in the stove top.

19. The method of claim 18 wherein the electricity provided is a 120 volt power supply.

20. The method of claim 18 wherein the one or more electrical cooking elements is configured to operate on a 15 amp, 20 amp, 30 amp, 50 amp, and/or 60 amp power supply.

21. The method of claim 18 wherein the one or more electrical cooking elements is at least one graphite heating element.

22. The method of claim 18 managing power supply to the range to the detriment of other electrical devices within the recreational vehicle.

23. The method of claim 18 further comprising the step of air frying food within the oven.

24. The method of claim 18 wherein the range includes one or more burners in another oven, and providing gas to the one or more gas burners in the another oven.
